(19) United States
(12) Patent Application Publication
(10) Pub. No.: US 2025/0379495 A1
(43) Pub. Date: Dec. 11, 2025

(54) POSITION DETECTION SYSTEM AND ACTUATOR

(71) Applicant: Fanuc Corporation, Minamitsuru-gun, Yamanashi (JP)

(72) Inventor: Taichi TAGUCHI, Minamitsuru-gun, Yamanashi (JP)

(73) Assignee: Fanuc Corporation, Minamitsuru-gun, Yamanashi (JP)

(21) Appl. No.: 18/877,103

(22) PCT Filed: Jul. 8, 2022
(86) PCT No.: PCT/JP2022/027153

§ 371 Date: Dec. 19, 2024

(51) Int. Cl. H02K 11/21; H02K 7/116

(52) U.S. Cl. CPC H02K 11/21; H02K 7/116

(57) ABSTRACT

This position detection system includes a primary encoder that detects the position of a motor shaft of a motor, a secondary encoder that detects the position of an output shaft of a reducer, and an additional reducer that is disposed between the output shaft and the secondary encoder. The reduction ratio of the additional reducer is set such that a rotating disc for the secondary encoder is within a single rotation of the entirety of the movable range of a machine provided with the motor and the reducer.

### CROSS REFERENCE TO RELATED APPLICATIONS

This is the U.S. National Phase application of PCT/JP2022/027153, filed Jul. 8, 2022, the disclosure of this application being incorporated herein by reference in its entirety for all purposes.

### FIELD OF THE INVENTION

The present invention relates to a position detection system and an actuator.

### BACKGROUND OF THE INVENTION

Actuators include a servo motor and a speed reducer that are connected to each other. A primary encoder is connected to a motor shaft of the servo motor for detecting an absolute position within one rotation of the motor shaft and the total number of rotations of the motor shaft. Likewise, a secondary encoder is connected to an output shaft of the speed reducer for detecting an absolute position within one rotation of the output shaft and the total number of rotations of the output shaft (refer to, for example, Japanese Unexamined Patent Publication (Kokai) No. 2007-113932). Information detected by each encoder is stored in a memory.

In specific situations, such as when the servo motor stops and the output shaft of the speed reducer rotates by inertia, as long as the output shaft of the speed reducer rotates within one rotation, the total number of rotations of the primary encoder can be obtained based on the absolute position information of the secondary encoder. In this case, each encoder can be used continuously without the use of an additional battery.

### PATENT LITERATURE

PTL 1: Japanese Unexamined Patent Publication (Kokai) No. 2007-113932

### SUMMARY OF THE INVENTION

The actuator described above may be incorporated into a specific machine, such as a robot, having a shaft which can rotate between +360° and +720° (between one and two rotations). If the shaft rotates between one and two rotations, an additional battery must be prepared to continue using each encoder.

Thus, an encoder which can be used continuously throughout the entire range of motion of a shaft without the need for an additional battery is desired.

According to a first aspect of the present disclosure, there is provided a position detection system comprising a primary encoder for detecting a position of a motor shaft of a motor, a secondary encoder for detecting a position of an output shaft of a speed reducer coupled to the motor, and an additional speed reducer arranged between the output shaft of the speed reducer and the secondary encoder, wherein a reduction ratio of the additional speed reducer is set so that a rotating disk for the secondary encoder rotates within one revolution over the entire movable range of a machine comprising the motor and the speed reducer.

Furthermore, according to another aspect, there is provided an actuator comprising a motor, a speed reducer coupled to the motor, a primary encoder for detecting a position of a motor shaft of the motor, a secondary encoder for detecting a position of an output shaft of the speed reducer, and an additional speed reducer arranged between the output shaft of the speed reducer and the secondary encoder, wherein a reduction ratio of the additional speed reducer is set so that a rotating disk for the secondary encoder rotates within one revolution over the entire movable range of a machine comprising the motor and the speed reducer.

The object, features, and advantages of the present disclosure will become more apparent from the following description of the embodiments in conjunction with the accompanying drawings.

### BRIEF DESCRIPTION OF THE DRAWINGS

FIG. 1 is a schematic side view of a position detection system based on a first embodiment of the present disclosure.

FIG. 2 is a front view of the additional speed reducer shown in FIG. 1.

FIG. 3 is a schematic side view of a position detection system based on a second embodiment of the present disclosure.

FIG. 4 is a diagram showing a modification example of FIG. 3.

### DETAILED DESCRIPTION OF EMBODIMENTS OF THE INVENTION

The embodiments of the present disclosure will be described below with reference to the attached drawings. In the drawings, corresponding constituent elements have been assigned common reference signs.

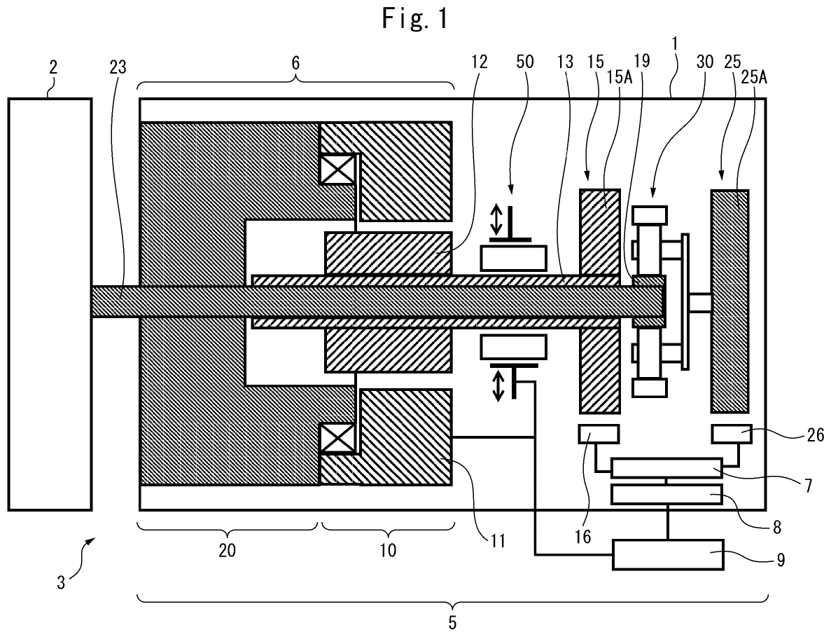

FIG. 1 is a schematic side view of a position detection system based on a first embodiment of the present disclosure. The position detection system 5 is incorporated into a machine 3 having a shaft, for example, a joint shaft of a robot 3. Though the case in which the position detection system 5 is incorporated into the robot 3 will be described below, the same applies to the case in which the position detection system 5 is incorporated into another machine 3 having a shaft, for example, a machine tool.

In FIG. 1, an actuator 6 arranged in a link 1 comprises a motor 10, for example, a servo motor and a speed reducer 20 connected to a motor shaft part 13 of the motor 10, which are connected with each other. The motor 10 comprises a rotor 12 which rotates integrally with the motor shaft 13, and a stator 11 arranged so as to surround the rotor 12. The tip of an output shaft 23 of the speed reducer 20 is connected to a link 2. Thus, the actuator 6 composed of the motor 10 and the speed reducer 20 rotates the link 2 relative to the link 1 within a predetermined operating range to perform positioning control thereof. The reduction ratio of the speed reducer 20 is, for example, 1:50.

The motor shaft 13 is, for example, a hollow shaft, and has a primary encoder 15 attached to a rear end thereof. The primary encoder 15 is, for example, an incremental encoder, and outputs A-phase, B-phase, and Z-phase signals. The output signals are detected by a detection unit 16, which detects an absolute position PA1 within one rotation of the motor shaft 13 and a total number of rotations PB1 of the motor shaft 13 by a known method. The detected information is stored in a memory 7, for example, a volatile memory.

The output shaft 23 extends through the hollow motor shaft 13 toward the motor 10, and a rear end of the output shaft 23 is connected to a secondary encoder 25 via an additional speed reducer 30, which will be described later. The secondary encoder 25 is, for example, an incremental encoder, and outputs A-phase, B-phase, and Z-phase signals. The output signals are detected by a detection unit 26, which detects an absolute position PA2 within one rotation of the output shaft 23 and a total number of rotations PB2 of the output shaft 23 by a known method. The detected information is stored in a memory 7, for example, a volatile memory. As is known, the primary encoder 15 and the secondary encoder 25 comprise respective rotating disks 15A, 25A.

The information stored in the memory 7 is capable of being stored for a certain period of time due to a battery 8, for example, a button battery or a capacitor. In FIG. 1, the primary encoder 15 and the secondary encoder 25 are provided with a common memory 7 and a common battery 8. However, the primary encoder 15 and the secondary encoder 25 may each have a separate memory and a separate battery.

The information stored in the memory 7 is supplied to a controller 9 for controlling the machine 3. The controller 9 may be an LSI mounted on the encoders 15 and 25. Based on the supplied information, the controller 9 drives and controls the motor 10, and performs a positioning operation to position the link 2 at a target position relative to the link 1. Further, a built-in brake 50 provided on the outer surface side of the motor shaft 13 is activated in response to an instruction from the controller 9 to brake the motor shaft 13. Furthermore, the controller 9 also serves to energize the primary encoder 15 and the secondary encoder 25 during operation of the machine 3 comprising the links 1 and 2.

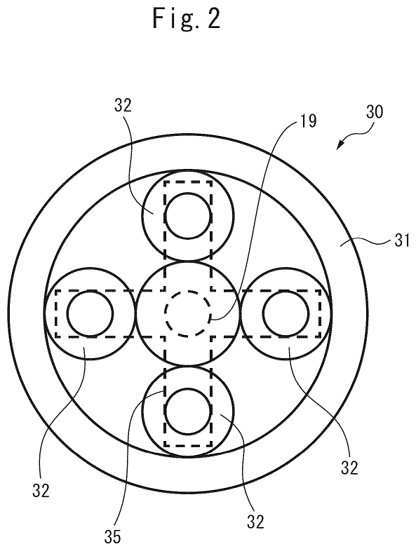

FIG. 2 is a front view of the additional speed reducer shown in FIG. 1. The additional speed reducer 30 of the first embodiment is a planetary gear device. In this case, the additional speed reducer 30 can be prepared at a relatively low cost. However, other speed reducer structures than a planetary gear device, such as a strain wave gear speed reducer or a cycloid speed reducer, may be used as the additional speed reducer 30.

The additional speed reducer 30 shown in FIG. 2 comprises a sun gear 19 which is fixed to the rear end of the motor shaft 13, a plurality (for example, four) of planetary gears 32 which engage with the sun gear 19, an outer ring 31 surrounding the plurality of planetary gears 32, and a carrier 35 which rotatably engages with each central shaft of the plurality of planetary gears 32. As can be understood from FIG. 1, a shaft portion extending from the center of the carrier 35 is coaxial with the motor shaft 13 of the motor 10 and the output shaft 23 of the speed reducer 20, and is connected to the rotating disk 25A of the secondary encoder 25.

As can be understood from FIG. 1, the additional speed reducer 30 is arranged between the output shaft 23 of the speed reducer 20 and the secondary encoder 25. The actuator 6 composed of the motor 10 and the speed reducer 20 may be arranged in a specific machine 3, for example, a robot 3, having a shaft part 23 that can rotate within a range of ±360° to ±720° (one rotation or more and two rotations or fewer).

In such a case, the reduction ratio of the additional speed reducer 30 is set so that the rotating disk 25A for the secondary encoder 25 rotates within one revolution over the entire movable range of the machine 3 comprising the motor 10 and the speed reducer 20.

In an embodiment, the outer diameter D1 of the sun gear 19 is 16 mm, and the inner diameter D2 of the outer ring 31 is 26 mm. The speed of the output shaft 23 is equal to the speed V1 of the sun gear 19, and the speed V2 of the outer ring 31 is equal to the speed of the rotating disk 25A of the secondary encoder 25. Thus, the speed V2 of the outer ring 31 can be expressed as D1/D2×V1=0.615×V1.

In the case in which the additional speed reducer 30 is not provided, when the movable range of the machine 3 is ±540° (±1.5 rotations), the rotating disk 25A of the secondary encoder 25 also rotates by ±540° (one rotation or more and two rotations or fewer). In this situation, the secondary encoder 25 cannot be continuously used.

However, in an embodiment in which the additional speed reducer 30 is provided, the movable range of the machine 3 of ±540° is converted to ±332° (=540×0.615), and thus, the rotating disk 25A of the secondary encoder 25 rotates by ±332°. In other words, by providing the additional speed reducer 30, the rotating disk 25A of the secondary encoder 25 rotates within one rotation (within ±360°).

In other words, the outer diameter D1 of the sun gear 19 and the inner diameter of the outer ring 31 should be set so as to satisfy the following conditions (1) and (2):
Condition (1): ±360°× D1/D2 is a value greater than ±zero, and
Condition (2): ±720°× D1/D2 is equal to or less than ±360°.

As long as these conditions are met, even when the shaft part 23 performs a rotational operation of one to two rotations, the secondary encoder 25 can be used continuously throughout the entire movable range of the output shaft 23 without the need for an additional battery. Specifically, in an embodiment of the present disclosure, it is possible to provide a position detection system 5 which can be used continuously throughout the entire movable range of the output shaft 23 without a battery, even when the shaft portion 23 performs a rotational operation of ±360° to ±720° (one rotation or more and two rotations or fewer). Note that the primary encoder 15 can also be used continuously throughout the entire movable range of the output shaft 23.

It is preferable that the position detection system 5 be incorporated into the joint shaft of the robot 3. The joint shaft of the robot 3 generally rotates between ±360° and ±720° (one rotation or more and two rotations or fewer). Thus, even in such a case, it is particularly advantageous in that the position detection system 5 can be used continuously without a battery within the above rotational movement range of the joint shaft.

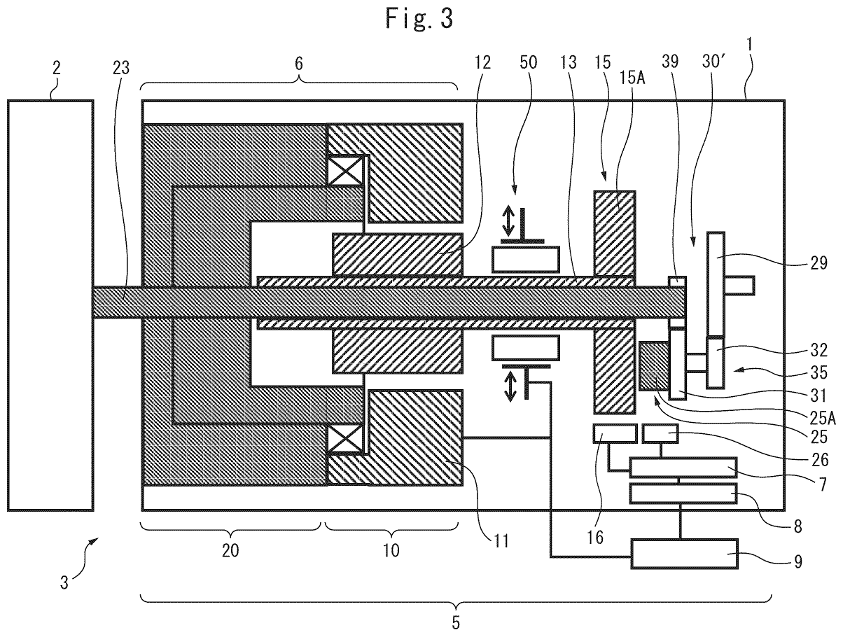

FIG. 3 is a schematic side view of a position detection system according to a second embodiment of the present disclosure. The additional speed reducer 30′ of the second embodiment is a combination of two spur gears and a two-stage gear. As shown in FIG. 3, the additional speed reducer 30′ comprises a spur gear 39 which is fixed to the rear end of the motor shaft 13, a two-stage gear 35 including a large diameter gear 31 and a small diameter gear 32, and a spur gear 29. As can be understood from FIG. 3, the spur gear 39 and the large diameter gear 31 of the two-stage gear 35 engage with each other, and the small diameter gear 32 of the two-stage gear 35 and the spur gear 29 engage with each other.

In FIG. 3, the secondary encoder 25 is arranged on the end surface of the large diameter gear 31. Thus, the secondary encoder 25 shown in FIG. 3 detects the speed of the output shaft 23 reduced by the first reduction ratio.

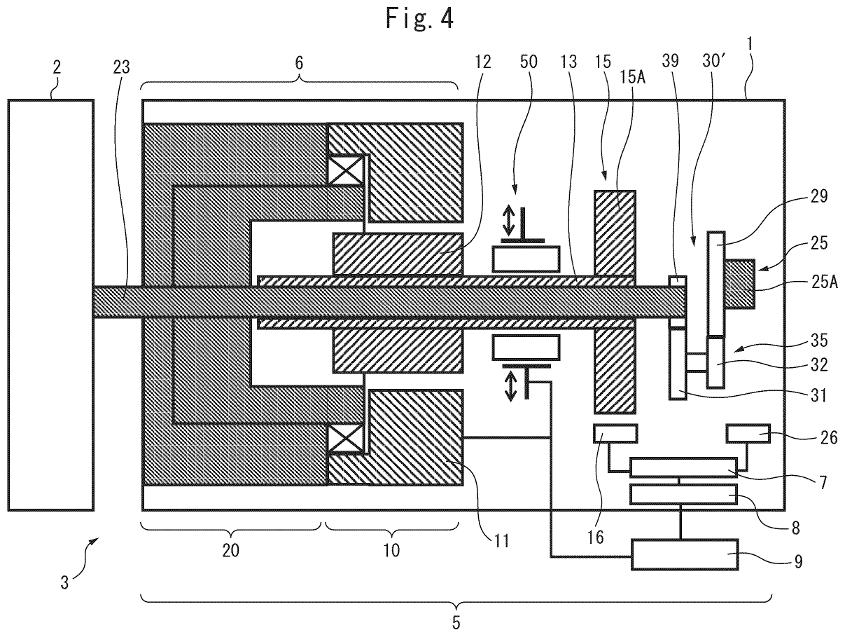

FIG. 4 is a diagram showing a modification example of FIG. 3. In FIG. 4, the same additional speed reducer 30′ as described above is provided. The secondary encoder 25 is arranged on the end surface of the spur gear 29. Thus, the secondary encoder 25 shown in FIG. 4 detects the speed of the output shaft 23 reduced by the first reduction ratio and the second reduction ratio.

In the second embodiment, the speed of the output shaft 23 is reduced by the first reduction ratio between the spur gear 39 and the large diameter gear 31 of the two-stage gear 35, and the speed of the output shaft 23 is reduced by the second reduction ratio between the small diameter gear 32 of the two-stage gear 35 and the spur gear 29. As described above, the reduction ratio of the additional speed reducer 30′ (the product obtained by multiplying the first reduction ratio by the second reduction ratio) is set so that the rotating disk 25A for the secondary encoder 25 rotates within one rotation over the entire movable range of the machine 3 comprising the motor 10 and the speed reducer 20. It will be understood that this provides the same effects as described above.

### Aspects of the Present Disclosure

According to a first aspect, there is provided a position detection system comprising a primary encoder for detecting a position of a motor shaft of a motor, a secondary encoder for detecting a position of an output shaft of a speed reducer coupled to the motor, and an additional speed reducer arranged between the output shaft of the speed reducer and the secondary encoder, wherein a reduction ratio of the additional speed reducer is set so that a rotating disk for the secondary encoder rotates within one revolution over the entire movable range of a machine comprising the motor and the speed reducer.

According to a second aspect, in the first aspect, the additional speed reducer is a planetary gear device, a strain wave gear speed reducer, a cycloid speed reducer, or a combination of a spur gear and a two-stage gear.

According to a third aspect, in the first or second aspect, the position detection system is mounted on a robot.

According to a fourth aspect, there is provided an actuator, comprising a motor, a speed reducer coupled to the motor, a primary encoder for detecting a position of a motor shaft of the motor, a secondary encoder for detecting a position of an output shaft of the speed reducer, and an additional speed reducer arranged between the output shaft of the speed reducer and the secondary encoder, wherein a reduction ratio of the additional speed reducer is set so that a rotating disk for the secondary encoder rotates within one revolution over the entire movable range of a machine comprising the motor and the speed reducer.

According to a fifth aspect, in the fourth aspect, the additional speed reducer is a planetary gear device, a strain wave gear speed reducer, a cycloid speed reducer, or a combination of a spur gear and a two-stage gear.

According to a sixth aspect, in the fifth or sixth aspect, the actuator is mounted on a robot.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

### REFERENCE SIGNS LIST

1, 2 link
3 machine (robot)
5 position detection system
6 actuator
7 memory
8 battery
9 controller
10 motor
11 stator
12 rotor
13 motor shaft
15 primary encoder
16 detection unit
20 speed reducer
23 output shaft
25 secondary encoder
26 detection unit
30, 30′ additional speed reducer
50 built-in brake

1. A position detection system comprising:
a primary encoder for detecting a position of a motor shaft of a motor,
a secondary encoder for detecting a position of an output shaft of a speed reducer coupled to the motor, and
an additional speed reducer arranged between the output shaft of the speed reducer and the secondary encoder, wherein
a reduction ratio of the additional speed reducer is set so that a rotating disk for the secondary encoder rotates within one revolution over the entire movable range of a machine comprising the motor and the speed reducer.

2. The position detection system according to claim 1, wherein the additional speed reducer is a planetary gear device, a strain wave gear speed reducer, a cycloid speed reducer, or a combination of a spur gear and a two-stage gear.

3. The position detection system according to claim 1, wherein the position detection system is mounted on a robot.

4. An actuator, comprising:
a motor,
a speed reducer coupled to the motor,
a primary encoder for detecting a position of a motor shaft of the motor,
a secondary encoder for detecting a position of an output shaft of the speed reducer, and
an additional speed reducer arranged between the output shaft of the speed reducer and the secondary encoder, wherein
a reduction ratio of the additional speed reducer is set so that a rotating disk for the secondary encoder rotates within one revolution over the entire movable range of a machine comprising the motor and the speed reducer.

5. The actuator according to claim 1, wherein the additional speed reducer is a planetary gear device, a strain wave gear speed reducer, a cycloid speed reducer, or a combination of a spur gear and a two-stage gear.

6. The actuator according to claim 1, wherein the actuator is mounted on a robot.
